(19) United States
(12) Patent Application Publication
(10) Pub. No.: US 2010/0042860 A1
(43) Pub. Date: Feb. 18, 2010

(54) RACK POWER SUPPLY SYSTEM AND METHOD OF CONTROLLING RACK POWER SUPPLY APPARATUS

(75) Inventors: Won Ok KWON, Daejeon (KR); Seong Woon KIM, Chungcheongnam-do (KR); Myung Joon KIM, Daejeon (KR)

Correspondence Address: LOWE HAUPTMAN HAM & BERNER, LLP, 1700 DIAGONAL ROAD, SUITE 300, ALEXANDRIA, VA, 22314, US

(73) Assignee: Electronics and Telecommunications Research Institute, Daejeon (KR)

(21) Appl. No.: 12/414,072

(22) Filed: Mar. 30, 2009

(30) Foreign Application Priority Data
Aug. 18, 2008 (KR) 10-2008-0080593

(51) Int. Cl. G06F 1/26

(52) U.S. Cl. 713/340

(57) ABSTRACT

Provided is a method of controlling a rack power supply system and a rack power supply apparatus. The system includes a plurality of computing devices mounted in a rack, and a rack power supply apparatus supplying the plurality of computing devices with direct current (DC) power. The rack power supply apparatus includes a plurality of power generating units and a control unit. The plurality of power generating units are supplied with alternating current (AC) power to generate the DC power. The control unit controls to turn on or off each power generating unit in consideration of power consumption.

### CROSS-REFERENCE TO RELATED APPLICATIONS

This application claims priority under 35 U.S.C. §119 to Korean Patent Application No. 10-2008-0080593, filed on Aug. 18, 2008, the disclosure of which is incorporated herein by reference in its entirety.

### TECHNICAL FIELD

The present disclosure relates to a rack power supply system and a method of controlling a rack power apparatus, and in particular, to a rack power supply system and a method of controlling a rack power supply apparatus capable of improving power efficiency of a data center.

### BACKGROUND

Recently, as many data centers such as the Internet portal enterprise with the data center operating hundreds of thousands of devices emerge around the world, Studies have been conducted to increase the power efficiency of the data center.

Referring to FIGS. 1A and 1B, a related art power supply and distribution method of a typical data center will be described. FIG. 1A is a block diagram illustrating the related art power supply system, and FIG. 1B is a block diagram illustrating the power supply system in FIG. 1A concretely.

First, referring to FIG. 1A, the related art power supply system 1 will be briefly described. High tension electricity generated from a power plant (not shown) is transformed to a voltage level of 300˜600V via substation 2. The high tension electricity is finally supplied to a rack 6 after sequentially passing a power delivery switch 3 taking charge of an electric power switching, an Uninterruptible Power Supply (UPS) 4, and a Power Distribution Unit (PDU) 5.

Referring to FIG. 1B, a power supply system supplying the electric power from the UPS 4 to the rack 6 will be more concretely explained as follows.

The UPS 4 includes an alternating current/direct current (AC/DC) converter 7 and a DC/AC converter 8, which is supplied with the three-phase electric powers of 300 V or more. The UPS 4 outputs a high voltage available for the data center by performing AC/DC conversion and DC/AC conversion using the AC/DC converter 7 and the DC/AC converter 8.

The voltage from the UPS 4 is transformed to 100V to 220V AC electric power via the PDU 5, and supplied to the rack 6 mounted with computing devices 9_1, 9_2 and 9_{—}n such as a server, a storage device and a switch.

Each of the computing devices 9_1, 9_2 and 9_{—}n includes a Power Supply Unit (PSU) 13 and a Voltage Regulator Module (VRM) 14. The PSU 13 includes an AC/DC converter 11 and a DC/DC converter 12. The PSU 13 converts the 100V to 220V AC electric powers supplied from PUD 5 to DC voltages of +12V, −12V, +5V and +3.3V available for various electronic parts (not shown) in the computing devices 9_1, 9_2 and 9_{—}n, and supplies the DC voltages to VRM 14. The VRM 14 transforms the supplied DC voltages to DC voltages available for the electronic parts (not shown).

As appreciated from the above description, the related art data center is accompanied with at least three times of AC/DC or DC/AC conversions and at least one time DC/DC conversions, which cause a loss of electric power. About 20% of the loss of electric power is caused by the PSU 13 in the computing devices 9_1, 9_2 and 9_{—}n.

Each of computing devices 9_1, 9_2 and 9_{—}n mounted in the related art data center includes the individual PSU 13, which causes a significant loss of electric power by performing AC/DC and DC/DC conversions in the process of producing the various DC voltages used in the computing devices 9_1, 9_2 and 9_{—}n from the 100V to 200V AC voltages.

Also, any method (or system) for efficiently supplying electric power, controlling the electric power supply, or monitoring the electric power supply in a unit of rack has not existed.

### SUMMARY

Accordingly, the present disclosure provides a rack power supply system capable of increasing a power efficiency of a data center.

The present disclosure also provides a method of controlling rack power supply unit capable of increasing a power efficiency of a data center.

According to an aspect, there is provided a rack power supply system comprising: a plurality of computing devices mounted in a rack; and a rack power supply apparatus supplying the plurality of computing devices with direct current (DC) power, the rack power supply apparatus comprising a plurality of power generating units supplied with alternating current (AC) power to generate the DC power, and a control unit controlling to turn on or off each power generating unit in consideration of power consumption.

According to another aspect, there is provided a method of controlling a rack power supply apparatus including a plurality of power generating units and supplying the rack power supply apparatus with power, the method including: determining a power consumption of the plurality of power generating units; and controlling to turn on or off each of the power generating units in consideration of the power consumption

According to the exemplary embodiments, the power efficiency can be increased by supplying power in consideration of a power consumption of a computing device mounted in a rack.

Also, it is possible to increase the power efficiency by changing only the power supply manner in a unit of the rack without any change in the power structure in the data centers, and to apply to the typical data center.

Furthermore, the rack power supply system and the data center can be efficiently managed by readily knowing the state of the rack power supply system and the data center via network.

### BRIEF DESCRIPTION OF THE DRAWINGS

The accompanying drawings, which are included to provide a further understanding of this present disclosure and are incorporated in and constitute a part of this specification, illustrate exemplary embodiments and together with the description serve to explain the principles of the exemplary embodiments.

FIG. 1A is a block diagram illustrating a related art power supply system;

FIG. 1B is a detailed block diagram illustrating the power supply system in FIG. 1A;

FIG. 2 is a block diagram illustrating a rack power supply system according to an exemplary embodiment;

FIG. 3 is a block diagram illustrating a rack power supply unit in FIG. 2;

FIG. 4 is a graph illustrating a method of controlling a rack power supply system and a rack power supply unit according to an exemplary embodiment;

FIG. 5 is a flowchart illustrating a method of controlling a rack power supply unit according to another exemplary embodiment;

FIG. 6 is a flowchart illustrating a method of controlling a rack power supply unit according to yet another exemplary embodiment;

FIG. 7A is a front view illustrating a rack power supply system according to an exemplary embodiment;

FIG. 7B is a front view illustrating the rack power supply unit in FIG. 7A;

FIG. 7C is a rear view illustrating the rack power supply unit in FIG. 7A;

FIG. 7D is an exemplary view illustrating a connection between the rack power supply unit and computing devices;

FIG. 8 is an exemplary view illustrating a management system for managing a rack power supply system according to an exemplary embodiment.

### DETAILED DESCRIPTION OF EMBODIMENTS

Advantages and features of the present disclosure, and a method of accomplishing them will be apparent with reference to embodiments which will be described in detail below together with the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. In the present specification, the same reference numeral indicates like element. Also, if one element is referred to as “connected to” another element, it may be a form of direct connection or coupling, or includes possible interposition of other elements. “And/or” includes each of items described herein, and one or more combination thereof. Terms used in the present specification are merely used for describing specific embodiments, which do not intend to limit the present invention. As far as singular expression clearly denotes a different meaning in context, it includes plural expression. In the present specification, it is understood that terms “comprises”, “comprising”, “includes” or “has” intend to indicate the existence of features, numerals, steps, operations, elements and components described in the present specification or the existence of the combination of these, and do not exclude the existence of one or more other features, numerals, steps, operations, elements and components or the existence of the combination of these or additional possibility beforehand.

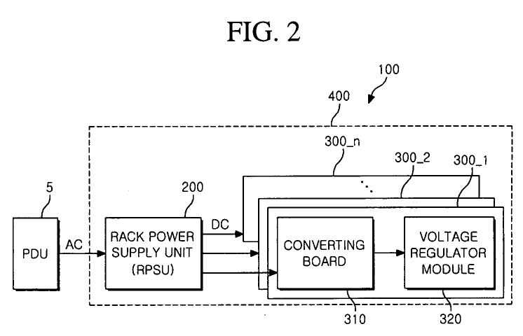

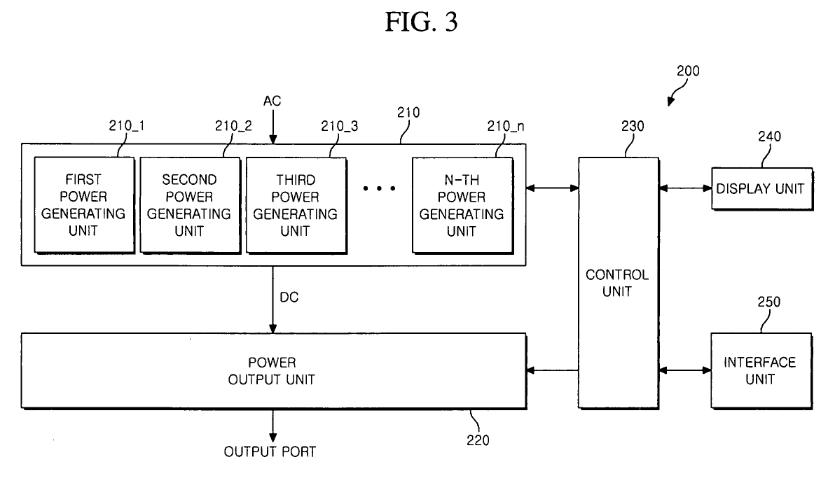

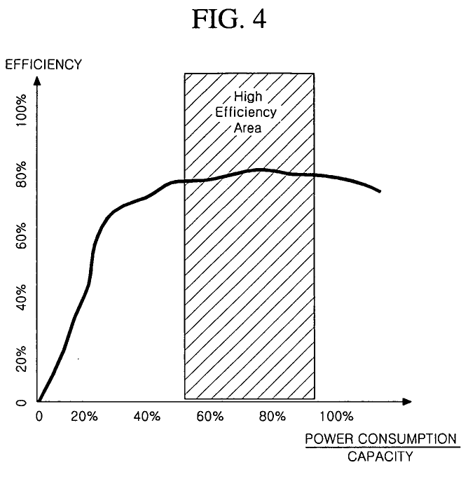

A method of controlling a rack power supply system and a rack power supply unit according to an exemplary embodiment will be described with reference to FIGS. 2 to 4. FIG. 2 is a block diagram illustrating a rack power supply system according to an exemplary embodiment. FIG. 3 is a block diagram illustrating a rack power supply unit in FIG. 2. FIG. 4 is a graph illustrating a method of controlling a rack power supply system and a rack power supply unit according to an exemplary embodiment.

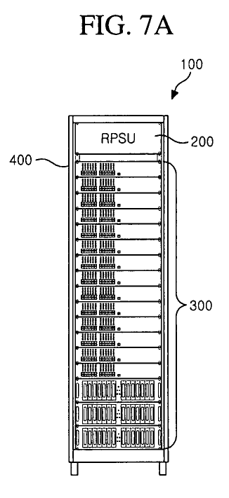

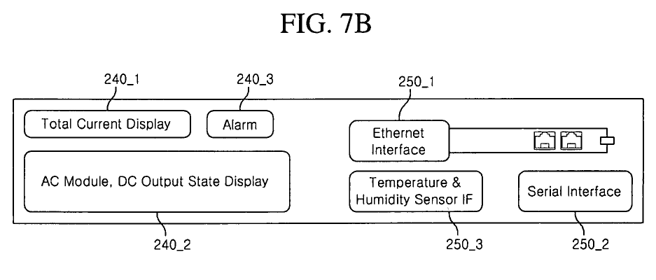

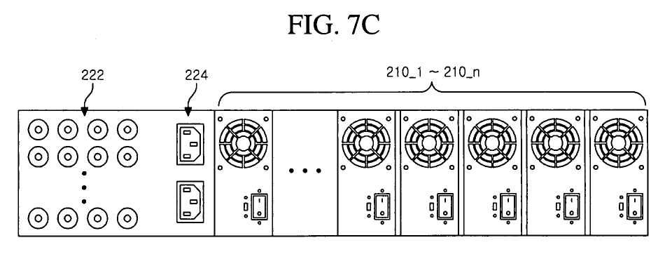

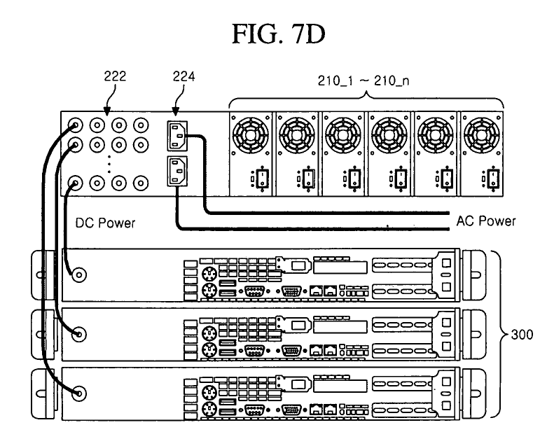

Referring to FIG. 2, the rack power supply system 100 includes a Rack Power Supply Unit (RPSU) 200, a plurality of computing devices 300_1, 300_2 and 300_{—}i, and a rack 400 mounted with a rack power supply unit 200 and a plurality of computing devices 300_1, 300_2 and 300_{—}i. An example of the rack mounted with the rack power supply unit 200 and the plurality of computing devices 300_1, 300_2 and 300_{—}i will be afterward described with reference to FIGS. 7A to 7D.

The rack power supply unit 200 transforms an AC power source, e.g., AC voltage and/or an AC electric current from power distribution unit 5 to a DC power source, e.g., a DC voltage and/or an AC electric current, which are supplied to the plurality of computing devices 300_1, 300_2 and 300_{—}i. One rack power supply unit 200 is provided for every rack, and takes charge of all electric powers consumed in the rack. For the convenience of explanation, the AC power source and the DC power source are considered an AC voltage and a DC voltage, respectively.

Each of computing devices 300_1, 300_2 and 300_{—}i may include a converting board 310 and a voltage regulator module 320. The converting board 310 transforms a DC voltage supplied from the rack power supply unit 200, e.g., a DC voltage of 10V˜100V to voltages necessary in the computing devices 300_1, 300_2 and 300_{—}i, e.g., 12V, 5V and 3.3V etc in the DC/DC conversion manner. The transformed voltages are provided to each electronic module of the computing devices 300_1, 300_2 and 300_{—}i via the voltage regulator module 320. However, at least one of the converting board 310 and the voltage regulator module 320 may not be included according to circumstances.

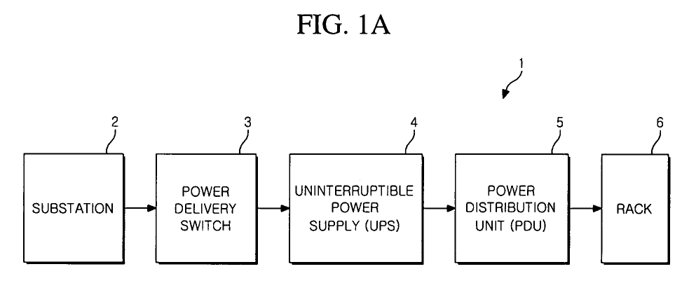

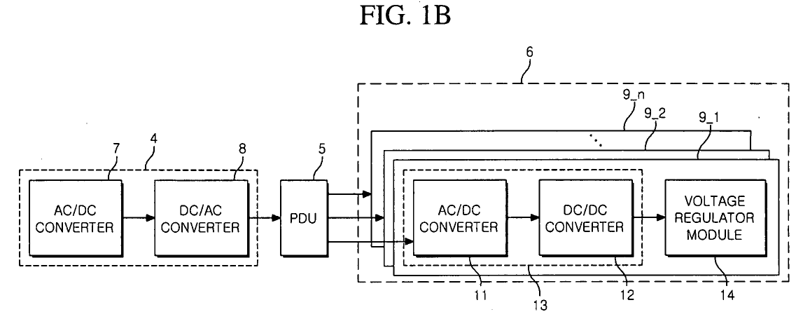

Due to this rack power supply unit 200, PSU 13 in FIG. 1B may be omitted from the computing devices 300_1, 300_2 and 300_{—}i. Accordingly, the multistep AC/DC conversions may be unnecessary. That is, 10˜100V DC voltage will be provided to the computing devices 300_1, 300_2 and 300_{—}i to increase the power efficiency. This rack power supply unit 200 will be more fully described with reference to FIG. 3.

Referring to FIG. 3, the rack power supply unit 200 may include a power generating module 210, a power output unit 220, a control unit 230, a display unit 240, and an interface unit 250.

The power generating module 210 includes the plurality of power generating units 210_1, 210_2, 210_3 and 210_{—}n, each of which is selectively turned on or off by the control of the control unit 230. When turned on, the power generating units 210_1, 210_2, 210_3 and 210_{—}n generate DC voltage DC from AC voltage. The plurality of power generating units 210_1, 210_2, 210_3 and 210_{—}n are supported with Hotplug. When the power generating units 210_1, 210_2, 210_3 and 210_{—}n are out of order, they can be immediately replaced. In order to monitor the supplied power of the rack power supply unit 200, state information of each power generating unit 210_1, 210_2, 210_3 and 210_{—}n, AC input power information and DC output power information may be delivered to the control unit 230.

The power output unit 220 takes charge of delivering the DC voltage from the power generating module 210 to the plurality of output ports. The plurality of computing devices 300_1, 300_2 and 300_{—}i connected to the output ports are supplied with the DC voltage DC. Here, the number of the output ports may be designed to be the maximum number of the computing devices 300_1, 300_2 and 300_{—}i connectable to the rack power supply unit 200. The output voltage and output current from each output port may vary with electric power which the computing devices 300_1, 300_2 and 300_{—}i connected to each output port consume. For example, DC voltage DC of 10V to 100V may be outputted. Meantime, amount of the output voltage or the output current from each output port may be delivered to the control unit 230, which can control ON/OFF of each output port.

The interface unit 250 may provide a serial interface for controlling the rack power supply unit 200 through a local access such as RS232 and Ethernet network, and a temperature and/or humidity input interface connected to a temperature and/or humidity sensor outside the rack. The air cooling of the data center may be controlled using temperature and/or humidity outside the rack perceived by the sensor.

The display unit 240 may display an input AC voltage AC, an output DC voltage DC, a warning, and a total consumption current of the plurality of computing devices 300_1, 300_2 and 300_{—}i connected to the rack power supply unit 200.

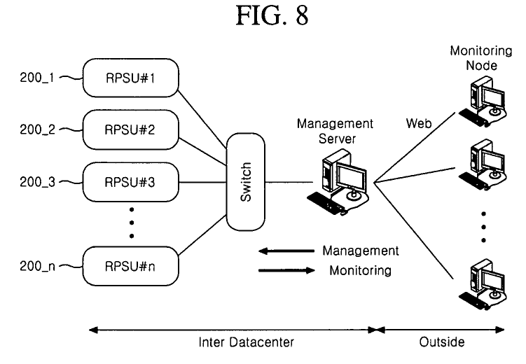

The control unit 230 controls the power generating module 210, the power output unit 220 and the display unit 240. The control unit 230 gathers and processes state information of the power generating module 210 and a power output unit 220, thereby displaying the state information through the display unit 240. To this end, the control unit 230 may include a processor, a memory and a user program logic (Field Programmable Gate Array (FPGA)). An operating system (OS) is embedded into the processor to operate a web server. The rack power supply unit 200 may be controlled and monitored through the web server. If the rack power supply unit 200 communicates with a management server (refer to FIG. 8) through the interface unit 250, the control unit 230 sends the collected state information, etc., to the management server.

Also, the control unit 230 numbers each power generating unit 210_1, 210_2, 210_3 and 210_{—}n in order to control the plurality of power generating units 210_1, 210_2, 210_3 and 210_{—}n individually . For example, the plurality of power generating units 210_1, 210_2, 210_3 and 210_{—}n are numbered from 1 to n, respectively, which are used to identify and control each power generating unit 210_1, 210_2, 210_3 and 210_{—}n. Otherwise, address may be assigned in a different manner from the above. In this case, a manner for identifying each power generating unit 210_1, 210_2, 210_3 and 210_{—}n may be determined according to a communication manner between the control unit 230 and the plurality of power generating units 210_1, 210_2, 210_3 and 210_{—}n.

A method by which the control unit 230 controls the power generating units 210_1, 210_2, 210_3 and 210_{—}n of the power generating module 210 will be described with the various embodiments below.

A method of controlling the rack power supply unit according to an exemplary embodiment will be described with reference to the FIG. 4. FIG. 4 is a graph illustrating a method of controlling a rack power supply system and a rack power supply unit according to an exemplary embodiment.

The graph in the FIG. 4 is the load-efficiency curve of the rack power supply unit 200. The X-axis is a ratio of the power consumption of the computing devices 300_1, 300_2 and 300_{—}i to the capacity of the rack power supply unit 200, and the Y-axis is the power efficiency of the rack power supply unit 200. The ratio of the power consumption of the computing devices 300_1, 300_2 and 300_{—}i to the capacity of the rack power supply unit 200 may be a ratio of the total power consumption of the plurality of computing devices 300_1, 300_2 and 300_{—}i mounted in the one of the rack to the total capacity of the plurality of power generating units 210_1, 210_2, 210_3 and 210_{—}n mounted in the one of the rack.

Referring to the graph in the FIG. 4, when the ratio of the power consumption of the computing devices 300_1, 300_2 and 300_{—}i to the capacity of the power generating units 210_1, 210_2, 210_3 and 210_{—}n is approximately 50% to 80%, the power efficiency of the rack power supply unit 200 is high. However, when the ratio of the power consumption of the computing devices 300_1, 300_2 and 300_{—}i to the capacity of the rack power supply unit 200 is approximately 30% or less, the power efficiency of the rack power supply unit 200 is relatively low.

Thus, the control unit 230 may control the plurality of power generating units 210_1, 210_2, 210_3 and 210_{—}n so that the ratio of the power consumption of the computing devices 300_1, 300_2 and 300_{—}i to the capacity of the power generating units 210_1, 210_2, 210_3 and 210_{—}n may be a predetermined ratio, e.g., 30% or more.

For example, it is assumed that the capacity of each power generating unit 210_1, 210_2, 210_3 and 210_{—}n is 500 W, the number of the power generating units 210_1, 210_2, 210_3 and 210_{—}n is five (n=5 in FIG. 3), and the power consumption of the computing devices 300_1, 300_2 and 300_{—}i is 700 W initially. When all of five power generating units 210_1, 210_2, 210_3 and 210_{—}n are turned on, a ratio becomes 28% (700/2500×100). When only four power generating units 210_1, 210_2, 210_3 and 210_4 are turned on (while one power generating units 210_{—}n is turned off), a ratio becomes 35% (700/2000×100). Accordingly, the control unit 230 turns on four power generating units 210_1, 210_2, 210_3 and 210_4, and turns off one power generating units 210_{—}n among five power generating units 210_1, 210_2, 210_3 and 210_{—}n.

That is, when only four power generating units 210_1, 210_2, 210_3 and 210_4 are turned on, the power efficiency is higher than all the power generating units 210_1, 210_2, 210_3 and 210_{—}n are turned on. In this case, the control unit 230 may turn off the power generating units 210_1, 210_2, 210_3 and 210_{—}n in a direction from the high number to the low number, and turn on the power generating units 210_1, 210_2, 210_3 and 210_{—}n in a direction from the low number to the high number. Otherwise, regardless of the numbered numeral, the control unit 230 may control the power generating units 210_1, 210_2, 210_3 and 210_{—}n in consideration of the aging (or degradation) of the power generating units 210_1, 210_2, 210_3 and 210_{—}n.

In the previous example, the case where the ratio is above 30% was described, but, without any limitation thereto, it may be determined based on the load-efficiency curve of the power generating units 210_1, 210_2, 210_3 and 210_{—}n. Furthermore, the plurality of power generating units 210_1, 210_2, 210_3 and 210_{—}n may be controlled using a certain range of, e.g., 60% to 90%.

For this control, the control unit 230 is connected to the plurality of power generating units 210_1, 210_2, 210_3 and 210_{—}n and the power output unit 220, and detects the power consumption of the computing device, 300_1, 300_2 and 300_{—}i to turn on or off each of the plurality of power generating units 210_1, 210_2, 210_3 and 210_{—}n. Also, the control unit 230 may detect periodically and repeatedly the power consumption of the computing devices 300_1, 300_2 and 300_{—}i for more precise and efficient control.

The method of controlling the rack power supply system and the rack power supply unit according to the exemplary embodiment can improve the power efficiency while still using the existing facilities such as UPS (4 in FIG. 1) and PDU (5 in FIG. 1) in the data center. Also, the rack power supply system can be remotely monitored using the display unit 240 and the interface unit 250.

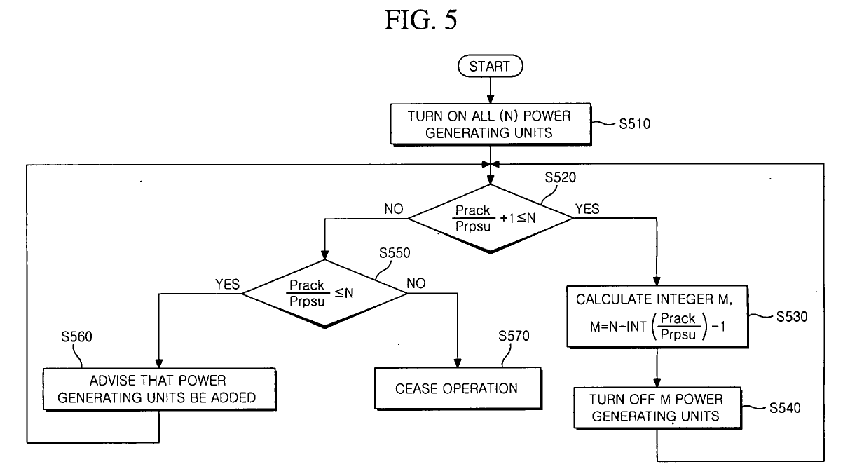

Referring to FIGS. 3 and 5, a method of controlling the rack power supply unit according to another exemplary embodiment will be described. FIG. 5 is a flowchart illustrating a method of controlling the rack power supply unit according 20 to another exemplary embodiment.

The method of controlling the rack power supply unit 200 according to the exemplary embodiment includes turning on the number of the power generating units 210_1, 210_2, 210_3 and 210_{—}n equal to the sum of at least a redundant number and the minimum number of the power generating units 210_1, 210_2, 210_3 and 210_{—}n, which are able to supply the electric power higher than the power consumption Prack of the plurality of computing devices 300_1, 300_2 and 300_{—}i. For example, it is assumed that the power consumption Prack of the plurality of computing devices 300_1, 300_2 and 300_{—}i is 1.3 kW, the capacity Prpus of each power generating unit 210_1, 210_2, 210_3 and 210_{—}n is 500 W, and the redundant number is 1. Though three of the power generating units 210_1, 210_2 and 210_3 can supply more than the power consumption Prack of 1.3 kW, the number of the power generating units 210_1, 210_2, 210_3 and 210_{—}n turned on is 4 by adding the redundant number. Thereby, it is possible to prepare for a case where any of the power generating units 210_1, 210_2, 210_3 and 210_{—}n may be out of order during operation. The redundant number may vary with operation conditions, but is considered 1 hereinafter.

If described more concretely with reference to FIGS. 3 and 5, in step S510, the control unit 230 turns on all of the power generating units 210_1, 210_2, 210_3 and 210_{—}n at the initial operation. On turning on, all of the power generating units 210_1, 210_2, 210_3 and 210_{—}n receive AC voltage to create DC voltage. The plurality of computing devices 300_1, 300_2 and 300_{—}i receive DC voltage, and consume it.

The control unit 230 detects the power consumption Prack which the plurality of computing devices 300_1, 300_2 and 300_{—}i consume. The control unit 230 divides the power consumption Prack by the capacity Prpus of each power generating unit 210_1, 210_2, 210_3 and 210_{—}n. In step S520, it is determined that the result Prack/Prpus+1, which is the sum of the divided result Prack/Prpus and the redundant number 1, is equal to or smaller than the number N of the plurality of power generating units 210_1, 210_2, 210_3 and 210_{—}n.

For example, it is assumed that the power consumption Prack which the plurality of computing devices 300_1, 300_2 and 300_{—}i consume is 1.3 kW, the capacity Prpus of the power generating units 210_1, 210_2, 210_3 and 210_{—}n is 500 W, and the number of the power generating units 210_1, 210_2, 210_3 and 210_{—}n is 5 (N=5). The control unit 230 divides the power consumption Prack 1.3 kW by capacity Prpus 500 W of each power generating unit 210_1, 210_2, 210_3 and 210_{—}n. It is determined that the result Prack/Prpus+1 3.6, which is the sum of the result Prack/Prpus 2.6 and the redundant number 1, is equal to or smaller than 5, the number N of the plurality of power generating units 210_1, 210_2, 210_3 and 210_{—}n.

It is determined how many power generating units 210_1, 210_2, 210_3 and 210_{—}n is turned off using 3.6, the result Prack/Prpus+1.

Since the result Prack/Prpus is 2.6, the plurality of computing devices 300_1, 300_2 and 300_{—}i may be operated though only three power generating units 210_1, 210_2 and 210_3 are turned on and supplies the DC power. Accordingly, two power generating units 210_1 and 210_2 of five power generating units 210_1, 210_2, 210_3 and 210_{—}n may be turned off. However, the number M of the power generating units 210_1, 210_2, 210_3 and 210_{—}n to be turned off may be determined using 3.6 including the redundant number 1 to prepare for a case where any of the power generating units 210_1, 210_2 and 210_3 is out of order during operation.

That is, in step of S530, the control unit 230 may determines the number M of the power generating units 210_1, 210_2, 210_3 and 210_{—}n to be turned off using the number of the plurality of power generating units 210_1, 210_2, 210_3 and 210_{—}n, the result Prack/Prpus, and the redundant number 1. Concretely, the control unit 230 may obtain 1, which is the number M of the power generating units 210_1, 210_2, 210_3 and 210_{—}n to be turned off, by subtracting an integer value of the result Prack/Prpus (INT 2.6=3) and the redundant number 1 from 5, which is the number N of the plurality of power generating units 210_1, 210_2, 210_3 and 210_{—}n. Also, the number M of the power generating units 210_1, 210_2, 210_3 and 210_{—}n may be obtained by subtracting 3.6 from 5, which the number of the plurality of power generating units 210_1, 210_2, 210_3 and 210_{—}n and cutting a decimal point of 1.4, which is the above result. The method of producing the number M is not limited to the above methods.

In step of S540, the control unit 230 5 turns off the number M of the power generating units 210_1, 210_2, 210_3 and 210_{—}n among five power generating units 210_1, 210_2, 210_3 and 210_{—}n. As described above, the control unit 230 may turn off the number M of the power generating units 210_1, 210_2, 210_3 and 210_{—}n in a direction from the power generating units 210_{—}n to the power generating units 210_1. Accordingly, the control unit 230 may turn off an n-th power generating units 210_{—}n.

Because the power consumption Prack of each computing devices 300_1, 300_2 and 300_{—}i is variable at any time, the control unit 230 may repeat the steps S520 to S540 by repeatedly detecting the power consumption of the plurality of computing devices 300_1, 300_2 and 300_{—}i.

Meanwhile, it is assumed that the power consumption Prack is 2.3 kW, the result of Prack/Prpus is 4.6, and the result of Prack/Prpus+1 is 5.6. The result Prack/Prpus+1 is 5.6 higher than 5, which is the number N of the power generating units 210_1, 210_2, 210_3 and 210_{—}n. In step S550, the control unit 230 determines if the result of Prack/Prpus is equal to or smaller than the number N of the power generating units 210_1, 210_2, 210_3 and 210_{—}n. In step S560, if the result of Prack/Prpus is smaller than the number N of the power generating units 210_1, 210_2, 210_3 and 210_{—}n, the control unit 230 advises the administrator to add a new power generating units 210_1, 210_2, 210_3 and 210_{—}n. That is, because the result of Prack/Prpus is 4.6, all of five power generating units 210_1, 210_2, 210_3 and 210_{—}n should be turned on in order to cope with the power consumption Prack of the computing device 300_1 and 300_2. Accordingly, the control unit 230 advises the administrator to enlarge the power generating units 210_1, 210_2, 210_3 and 210_{—}n for a failure of any of the power generating units 210_1, 210_2, 210_3 and 210_{—}n.

However, if the result Prack/Prpus is greater than the number N of the power generating units 210_1, 210_2, 210_3 and 210_{—}n, the power consumption Prack of the computing devices 300_1, 300_2 and 300_{—}i exceeds the capacity Prpus of five power generating units 210_1, 210_2, 210_3 and 210_{—}n. Accordingly, in step S570, the control unit 230 ceases operation by turning off all of the power generating units 210_1, 210_2 and 210_3, 210_{—}n.

When any of the power generating units 210_1, 210_2, 210_3 and 210_{—}n is failed, the control unit 230 may replace the failed power generating units with the redundant power generating units 210_1, 210_2, 210_3 and 210_{—}n, and number the power generating units 210_1, 210_2, 210_3 and 210_{—}n again for control. For example, if a second power generating units 210_2 is failed and replaced, a third power generating units 210_3 is numbered with the second power generating units 210_2, and likewise, the power generating units 210_{—}n is numbered with an (n−1)-th power generating units.

With the control method according to the exemplary embodiment, it is possible to efficiently manage the power supply by changing only a power supply manner in a rack level while still using the existing facilities such as UPS (4 in FIG. 1) and PDU (5 in FIG. 1) in the data center. Also, it is possible to stably control the rack power supply system because the redundant number of the power generating units 210_1, 210_2, 210_3 and 210_{—}n are additionally turned on for a failure of any of power generating units 210_1, 210_2, 210_3 and 210_{—}n. Furthermore, the rack power supply system can be remotely monitored using the display unit 240 and the interface unit 250.

The redundant number may vary in consideration of the load-efficiency curve of the rack power supply unit 200 as described above. For example, when the redundant number decreases, a ratio of the total power consumption Prack to the capacity of power generating units 210_1, 210_2, 210_3 and 210_{—}n, i.e., a value of X-axis of the graph in FIG. 4 increases. When the redundant number increases, the 10 value of X-axis decreases. Accordingly, the redundant number can vary so that the power efficiency of the rack power supply unit 200 becomes the maximum. In this case, the control unit 230 may take charge of varying the redundant number, and the administrator may vary it through the interface unit 250.

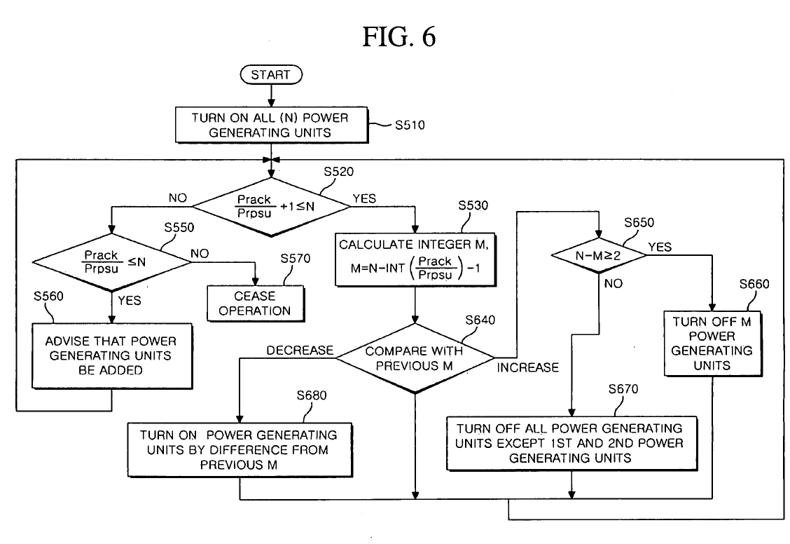

A method of controlling the rack power supply unit according to yet another exemplary embodiment will be hereinafter described with reference to FIG. 3 and 6. FIG. 6 is a flowchart illustrating a method of controlling a rack power supply unit according to yet another exemplary embodiment.

Referring to the FIG. 6, in the method of controlling the rack power supply unit 200 according to yet another exemplary embodiment, descriptions of steps identical to steps S510 to S530, and steps S550 to S570 in the previous exemplary embodiment will be below abbreviated except different parts from the previous exemplary embodiment. The number of the power generating units 210_1, 210_2, 210_3 and 210_{—}n is also considered five in this exemplary embodiment.

In step S530, the control unit 230 may determine the number M of the power generating units 210_1, 210_2, 210_3 and 210_{—}n to be turned off using the number N the plurality of power generating units 210_1, 210_2, 210_3 and 210_{—}n, a result Prack/Prpus obtained by dividing the power consumption Prack of the computing devices 300_1, 300_2 and 300_{—}i by capacity Prpus, the redundant number.

In step S640, the control unit 230 compares the currently-calculated number M with the previously-calculated number of the power generating units 210_1, 210_2, 210_3 and 210_{—}n.

When the currently-calculated number M is more than the previously-calculated number, i.e., the number of the power generating units 210_1, 210_2, 210_3 and 210_{—}n to be turned off increases, the calculated number M of the power generating units 210_1, 210_2, 210_3 and 210_{—}n may be turned off.

In this exemplary embodiment, when the minimal-turn-on-number (e.g., 2) of the power generating units 210_1, 210_2, 210_3 and 210_{—}n are intended to be maintained to turn on regardless of the calculated number M, the control unit 230 may turn on two power generating units 210_1 and 210_2, and turn off the calculated number M of power generating units out of the residual three of the power generating units. That is, the minimal-turn-on-number is the number of the power generating units which are controlled to turn on regardless of the calculated number M.

In this exemplary embodiment for this control, in step S650, the control unit 230 may determine if a result N−M obtained by subtracting the currently-calculated number M from 5, which is the number of the power generating units 210_1, 210_2, 210_3 and 210_{—}n, is equal to or more than the minimal-turn-on-number. If the result N−M is equal to or greater than the minimal-turn-on-number, in step S660, the control unit 230 turns off as many power generating units 210_1, 210_2, 210_3 and 210_{—}n as the calculated number M. If the result N−M is smaller than the minimal-turn-on-number, in step S670, the control unit 230 may turn on the minimal-turn-on-number of the power generating units 210_1 and 210_2, and turn off all of the residual power generating units 210_3 and 210_{—}n.

For example, if the calculated number M is 2, the result N−M obtained by subtracting 2 from 5, which is the number of the power generating units 210_1, 210_2 and 210_3, 210_{—}n, is 3. Because 3 is more than the minimal-turn-on-number which is 2, the control unit 230 turns off two power generating units 210_3 and 210_{—}n. In this case, two power generating units 210_1 and 210_2 corresponding to the minimal-turn-on-number stay turned on.

Meanwhile, if the calculated number M is 4, the result N−M obtained by subtracting 4 from 5, which is the number of the power generating units 210_1, 210_2 and 210_3, 210_{—}n, is 1. Because 1 is smaller than the minimal-turn-on-number which is 2, the control unit 230 turns on two power generating units 210_1 and 210_2, and turns off the residual three power generating units regardless of the calculated number M. In this case, two power generating units 210_1 and 210_2 corresponding to the minimal-turn-on-number also stay turned on.

Here, the control unit 230 may turn off four power generating units 210_2, 210_3 and 210_{—}n according to the calculated number M. In this case, if the only power generating units 210_1 is out of order, the computing devices 300_1, 300_2 and 300_{—}i may not be supplied with power. Accordingly, in this exemplary embodiment, because the control unit 230 turns on at least two power generating units 210_1 and 210_2 in consideration of the minimal turn-on number regardless of the calculated number M, it is possible to prepare for possible failure of the power generating units 210_1, 210_2, 210_3 and 210_{—}n.

According to the yet another exemplary embodiment, the method of controlling the rack power supply apparatus, in the step S650, includes determining, by the control unit 230, if the result N-M obtained by subtracting the calculated number M from the number of the power generating units 210_1, 210_2, 210_3 and 210_{—}n is equal to or more than the minimal-turn-on-number to turn on the minimal-turn-on-number of the power generating units 210_1, 210_2, 210_3 and 210_{—}n, but not limited to thereto. For example, while always turning on the first and second power generating units 210_1 and 210_2 out of five power generating units 210_1, 210_2, 210_3 and 210_{—}n, the control unit 230 selectively turns on or off the residual three power generating units 210_3 and 210_{—}n according to the calculated number M. In this case, the step S650 may be omitted.

In these exemplary embodiments, it was assumed that the minimal-turn-on-number was 2, but not limited thereto. Rather, the minimal-turn-on-number may vary. The administrator may vary the minimal-turn-on-number through the interface unit 250 from the outside.

The control methods according to the exemplary embodiments also include turning off, by the control unit 230, the power generating units 210_1, 210_2, 210_3 and 210_{—}n according to the calculated number M regardless of the minimal-turn-on-number.

In step S680, when the currently-calculated number M_{c} get smaller than the previously-calculated number Mₚ, the number of the power generating units 210_1, 210_2, 210_3 and 210_{—}n corresponding to a difference between the currently-calculated number M_{c} and the previously-calculated number Mₚ are additionally turned on.

For example, when the power consumption Prack of the computing devices 300_1, 300_2 and 300_{—}i increases from 1.3 kW to 1.8kW, the calculated number M varies from 1 (=5−INT(2.6)−1) to 0 (=5−INT(3.6)−1). Thus, when the power consumption Prack is 1.3 kW, one power generating units 210_{—}n of five power generating units 210_1, 210_2, 210_3 and 210_{—}n stays turned off. However, when the power consumption Prack increases to 1.8 kW, the control unit 230 turns on the power generating units 210_{—}n.

Next, when the currently-calculated number M_{c} is identical to the previous-calculated number Mₚ, the control unit 230 holds the power generating units 210_1, 210_2, 210_3 and 210_{—}n in a current turn-on or off state.

And, because the power consumption Prack of the computing devices 300_1, 300_2 and 300_{—}i varies on occasion, the control unit 230 returns to the step S520 to repeat the following steps as describe above. Thus, the control unit 230 may turn on or off the power generating units 210_1, 210_2, 210_3 and 210_{—}n according to the variable power consumption.

Structures of a rack power supply system and a rack power supply unit according to an exemplary embodiment will be described with reference to FIGS. 7A to 7D. FIG. 7A is a front view illustrating a rack power supply system according to an exemplary embodiment. FIG. 7B is a front view illustrating the rack power supply unit in FIG. 7A. FIG. 7C is a rear view illustrating the rack power supply unit in FIG. 7A. FIG. 7D is an exemplary view illustrating a connection between the rack power supply unit and computing devices.

Referring to FIG. 7A, the rack power supply system 100 according to the exemplary embodiment includes a rack 400, a plurality of computing devices 300 mounted to the rack 400, and a rack power supply unit 200 mounted to the rack 400 and supplying the plurality of computing device 300 with power source.

Referring to FIG. 7B, at least one of display unit 240 and the interface unit 250 is installed at the front surface of the rack power supply unit 200.

The display unit 240 includes a total current display 240_1, an AC module and DC output state display 240_2, and an alarm 240_3. The total current display 240_1 displays the total consumption of AC current at the power generating module. The AC module and DC output state display 240_2 displays whether each of power generating unit 210_1, 210_2, 210_3 and 210_{—}n operates or fails, and also displays DC voltage output state.

The interface unit 250 includes an Ethernet interface 250_1 and a serial interface 250_2.

Also, at the front face of the rack power supply unit 200, the interface unit 250 may further include a temperature and humidity sensor interface 250_3, through which temperature and humidity outside the rack is inputted.

Referring to FIG. 7C, n power generating units 210_1, 210_2, 210_3 and 210_{—}n, m C output ports 222, Dual AC power input port 224 are provided on the rear face of the rack power supply unit 200. n power generating units 210_1, 210_2, 210_3 and 210_{—}n may be installed in Hotplug form. m DC output ports 222 are connected to the computing devices 300_1, 300_2 and 300_{—}i with a jack form. The Dual AC power input port 224 is a dual input connector supplied from PDU 5 (in FIG. 2) with AC power.

Referring FIG. 7d, the connection between the rack power supply unit 20 200 and a plurality of computing devices 300 is shown. The plurality of computing devices 300 are connected to DC output ports 222 of the rack power supply unit 200 with power cable, and receive DC power.

A management system of a rack power supply system according to an exemplary embodiment will be described with reference to FIG. 8. FIG. 8 is an exemplary view illustrating a management system for managing a rack power supply system according to an exemplary embodiment.

Referring to FIG. 8, a connection between the plurality of rack power supply unit 200_1, 200_2, 200_3 and 200_{—}n and the management server is shown. The rack power supply units 200_1, 200_2, 200_3 and 200_{—}n are connected to the management server via network. If each of the rack power supply unit 200_1, 200_2, 200_3 and 200_{—}n delivers state information to the management server, the management server monitors each rack power supply unit 200_1, 200_2, 200_3 and 200_{—}n using the state information.

For example, the management server is provided with temperature information and/or humidity information from the rack power supply units 200_1, 200_2, 200_3 and 200_{—}n. By using the temperature information and/or humidity information, the management server may monitor and control the internal temperature and/or humidity of the data center, which is provided with the rack power supply unit 200_1, 200_2, 200_3 and 200_{—}n. That is, it is possible to manage the internal cooling of the data center efficiently.

Also, it is possible to access the state information of each rack power supply unit 200_1, 200_2, 200_3 and 200_{—}n from a monitoring node of the data center via web access.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and numbers that fall within the metes and bounds of the claims, or equivalents of such metes and bounds are therefore intended to be embraced by the appended claims.

What is claimed is:

1. A rack power supply system comprising:
a plurality of computing devices mounted in a rack; and
a rack power supply apparatus supplying the plurality of computing devices with direct current (DC) power, the rack power supply apparatus comprising:
a plurality of power generating units supplied with alternating current (AC) power to generate the DC power; and
a control unit controlling to turn on or off each power generating unit in consideration of power consumption.

2. The system of claim 1, wherein the control unit controls to turn on or off so that a ratio of the power consumption to a capacity of the power generating units is equal to or greater than a predetermined ratio.

3. The system of claim 1, wherein the control unit controls to turn on at least number of the power generating units equal to or more than a sum of a predetermined redundant number and a minimal-turn-on-number of the power generating units capable of generating the power consumption.

4. The system of claim 3, wherein the control unit divides the power consumption by the capacity of the power generating unit, determines if a sum of the redundant number and the dividing result is equal to or smaller than the number of the power generating units, and selectively turns on or off at least one of the power generating units according to the determining result.

5. The system of claim 4, wherein if the sum is equal to or smaller than the number of the power generating units, the control unit calculates number of the power generating units to be turned off using the number of the power generating units, the dividing result and the redundant number, and turns off the number of the power generating units by the calculated number.

6. The system of claim 4, wherein if the sum is equal to or smaller than the number of the power generating units, the control unit calculates number of the power generating units to be turned off using the number of the power generating units, the dividing result and the redundant number, turns on a minimal-turn-on-number of the power generating units, and turns off the calculated number of the power generating units out of number of power generating units obtained by subtracting the minimal-turn-on-number from the number of the power generating units, wherein the minimal-turn-on-number of power generating units are controlled to be turned on regardless of the calculated number.

7. The system of claim 4, wherein if the sum is equal to or smaller than the number of the power generating units, the control unit calculates number of the power generating units to be turned off using the number of the power generating units, the dividing result and the redundant number, and if the calculated number is smaller a previous calculated number, the control unit turns on more power generating units by a differential number between the calculated number and the previous calculated number.

8. The system of claim 4, wherein, when the sum is greater than the number of the power generating units, the control unit turns off all of the power generating units if the dividing result is greater than the number of the power generating units.

9. The system of claim 4, wherein, when the sum is greater than the number of the power generating units, the control unit advises that the power generating units be added if the dividing result is equal to or smaller than the number of the power generating units.

10. The system of claim 1, wherein the rack power supply apparatus further comprises a display unit displaying state information of the rack power supply apparatus.

11. The system of claim 1, wherein the rack power supply apparatus further comprises an interface unit transmitting state information of the rack power supply apparatus to a management server.

12. The system of claim 11, wherein the state information comprises at least one of temperature information and humidity information around the rack power supply apparatus, and the management server monitors and manages at least one of the internal temperature and the of the data center, which is provided with the rack power supply unit, using the state information.

13. A method of controlling a rack power supply apparatus comprising a plurality of power generating units and supplying the rack power supply apparatus with power, the method comprising:
determining a power consumption of the plurality of power generating units; and
controlling to turn on or off each of the power generating units in consideration of the power consumption.

14. The method of claim 13, wherein the controlling of the turning on or off comprises turning on number of the power generating units equal to or greater than a sum of a predetermined redundant number and a minimal-turn-on-number of the power generating units capable of generating the power consumption.

15. The method of claim 14, wherein the controlling of the turning on or off comprises:
dividing the power consumption by the capacity of the power generating unit;
determining if a sum of the redundant number and the dividing result is equal to or smaller than the number of the power generating units; and
selectively turning on or off at least one of the power generating units according to a determining result.

16. The method of claim 15, wherein, if the sum is equal to or smaller than the number of the power generating units, the turning on or off comprises:
calculating number of the power generating units to be turned off using the number of the power generating units, the dividing result and the redundant number; and
turning off the number of the power generating units by the calculated number.

17. The method of claim 15, wherein, if the sum is equal to or smaller than the number of the power generating units, the turning on or off comprises:
calculating number of the power generating units to be turned off using the number of the power generating units, the dividing result and the redundant number;
turning on a minimal-turn-on-number of the power generating units; and
turning off the calculated number of the power generating units out of number of power generating units obtained by subtracting the minimal-turn-on-number from the number of the power generating units,
wherein the minimal-turn-on-number of power generating units controlled to be turned on regardless of the calculated number.

18. The method of claim 15, wherein, if the sum is equal to or smaller than the number of the power generating units, the turning on or off comprises:
calculating number of the power generating units to be turned off using the number of the power generating units, the dividing result and the redundant number; and
turning on more power generating units by a differential number between the calculated number and the previous calculated number if the calculated number is smaller a previous calculated number.

19. The method of claim 15, wherein, when the sum is greater than the number of the power generating units, the controlling of the turning on or off comprises turning off all of the power generating units if the dividing result is greater than the number of the power generating units.

20. The method of claim 15, wherein, when the sum is greater than the number of the power generating units, the controlling of the turning on or off comprises advising that the power generating units be added if the dividing result is equal to or smaller than the number of the power generating units.
